(19) United States
(12) Patent Application Publication
(10) Pub. No.: US 2010/0142309 A1
(43) Pub. Date: Jun. 10, 2010

(54) MECHANICAL HANDLING SYSTEM FOR CEMENT

(75) Inventors: JASON LEE COTTRELL, MOGADORE, OH (US); MICHAEL DAVID SCHORY, LOUISVILLE, OH (US)

Correspondence Address: HARNESS, DICKEY & PIERCE, P.L.C., P.O. BOX 828, BLOOMFIELD HILLS, MI, 48303, US

(73) Assignee: Schorline, L.L.C., Louisville, OH (US)

(21) Appl. No.: 12/632,145

(22) Filed: Dec. 7, 2009

Related U.S. Application Data
(60) Provisional application No. 61/120,609, filed on Dec. 8, 2008.

(51) Int. Cl. B28C 7/04; B28C 5/46

(52) U.S. Cl. 366/7; 366/19; 366/18; 366/17; 366/8

(57) ABSTRACT

A cement handling system may include an aggregate container, a first component container, a second component container, and a metered water supply. The first component container may house a first mortar component and may include a metered opening in communication with the aggregate container. The second component container may be isolated from the first component container and may house a second mortar component. The second component container may include a second metered opening in communication with the aggregate container. The metered water supply may be in communication with the aggregate container.

### CROSS-REFERENCE TO RELATED APPLICATIONS

This application claims the benefit of U.S. Provisional Application No. 61/120,609, filed on Dec. 8, 2008. The disclosure of the above application is incorporated herein by reference in its entirety.

### FIELD

The present disclosure relates to a mechanical handling system for cement

### BACKGROUND

This section provides background information related to the present disclosure which is not necessarily prior art.

Dry mortar mixtures may be provided in premixed containers at worksites where the mixture is combined with water for use. These premixed mortar mixtures may include of a variety of components, such as cement, sand, colored dye, slag, kaolin clay, silica fume, fly ash, and all grades of gravel, limestone or slag aggregate and admixtures, stainless steel slag, pumas, bottom ash, calcium carbonate and the like. Over time, the heavier substances in the mixture may settle within a container. When the mixture is added to a mixing unit, the lighter weight substances may be added first as these substances may be located at the top of the container due to the settling. This may lead to mortar mixture inconsistencies including reduced compressive strength, adhesion properties, and color inconsistencies.

### SUMMARY

This section provides a general summary of the disclosure, and is not comprehensive of its full scope or all of its features.

As discussed above, conventional handling systems for cement may have one or more drawbacks in that for example, components in a premixed mortar mixture may settle within a container resulting in lighter weight substances being located at the top of the container and heavier substances settling to the bottom. This settling creates mortar mixture inconsistencies. Separating the individual mortar components from one another until the mixture is combined with water prevents this settling and provides for a more consistent composition. In various aspects, cement handling systems and methods are provided that address these concerns.

For example, a cement handling system may include an aggregate container, a first component container, a second component container, and a metered water supply. The first component container may house a first mortar component and may include a metered opening in communication with the aggregate container. The second component container may be isolated from the first component container and may house a second mortar component. The second component container may include a second metered opening in communication with the aggregate container. The metered water supply may be in communication with the aggregate container.

The cement handling system may additionally include a third component container isolated from the first and second containers. The third component container may house a third mortar component and may include a third metered opening in communication with the aggregate container.

The mortar components may include cement, sand, colored dye, slag, kaolin clay, silica fume, fly ash, and all grades of gravel, limestone or slag aggregate and admixtures, stainless steel slag, pumas, bottom ash, calcium carbonate and the like.

A cement handling method may include segregating first and second mortar components from one another at a worksite in first and second component containers. The first component container may be opened for a first predetermined time to provide a first predetermined amount of the first mortar component to an aggregate container. The second component container may be opened for a second predetermined time to provide a second predetermined amount of the second mortar component to the aggregate container. The first and second mortar components may be combined in the aggregate container at the worksite. A predetermined amount of water may be provided to the aggregate container based on the combination of the first and second mortar components.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a first side plan view of a cement handling system according to the present disclosure;

FIG. 2 is a second side plan view of the cement handling system of FIG. 1;

FIG. 3 is a third side plan view of the cement handling system of FIG. 1; and

FIG. 4 is a top plan view of the cement handling system of FIG. 1.

Corresponding reference numerals indicate corresponding parts throughout the several views of the drawings.

### DETAILED DESCRIPTION

Example embodiments will now be described more fully with reference to the accompanying drawings.

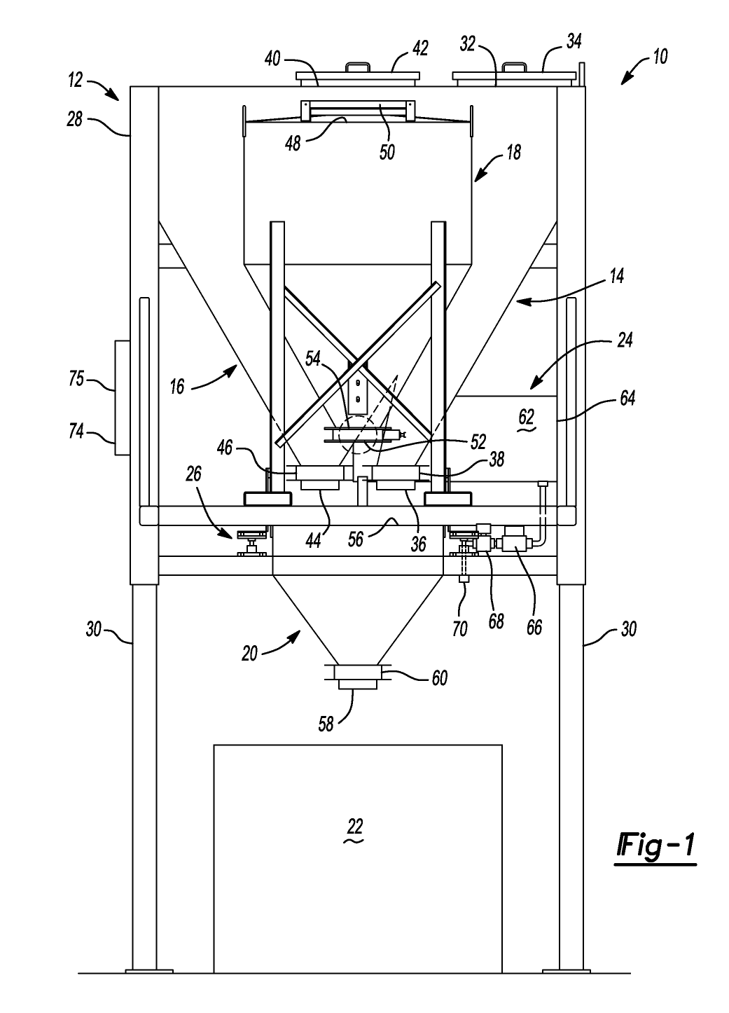

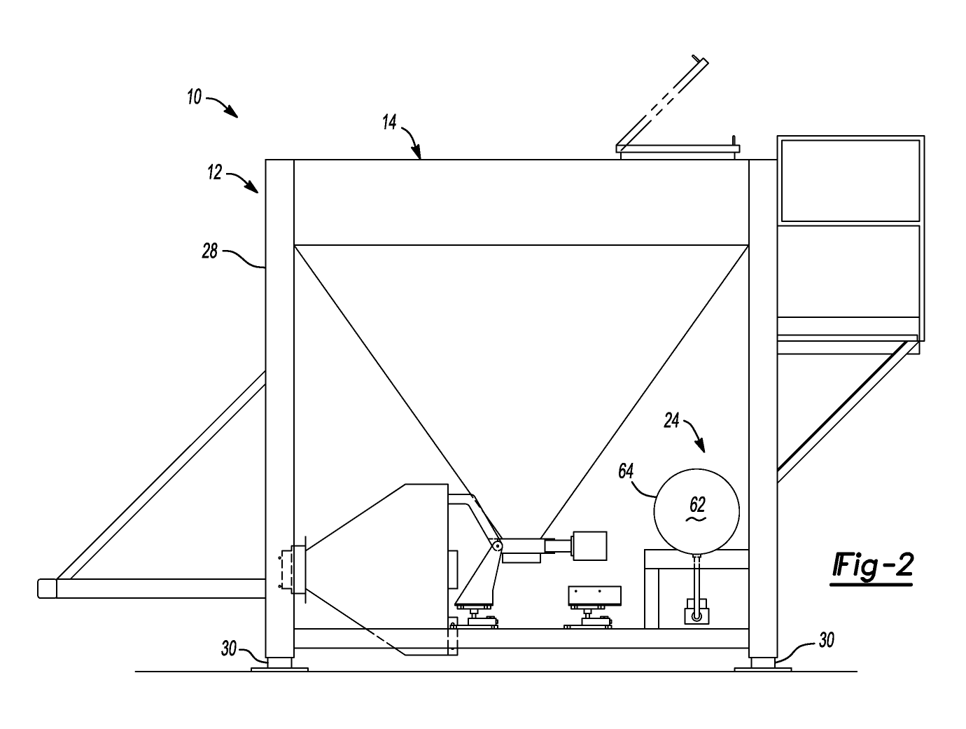

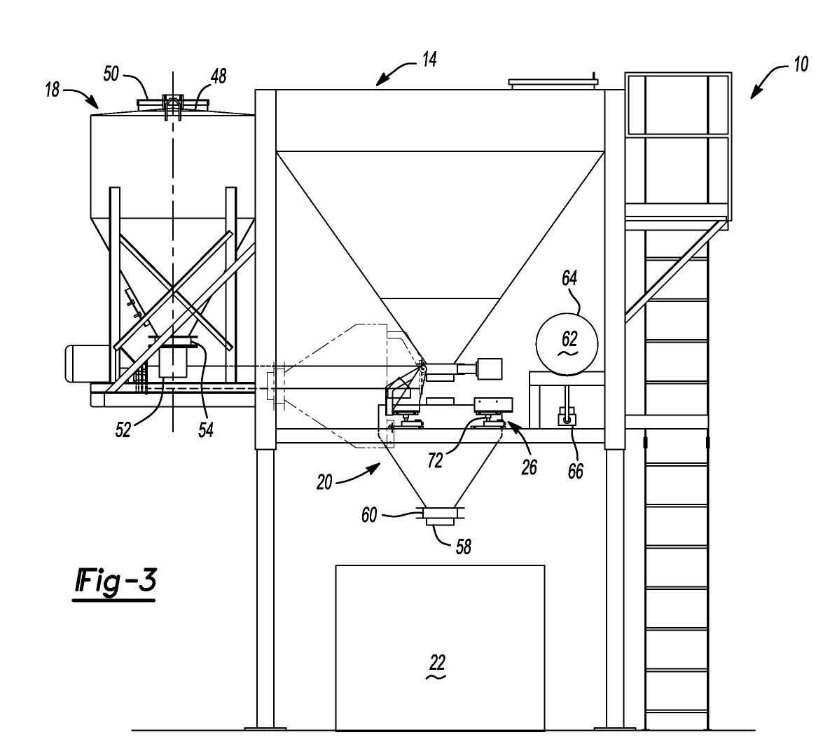

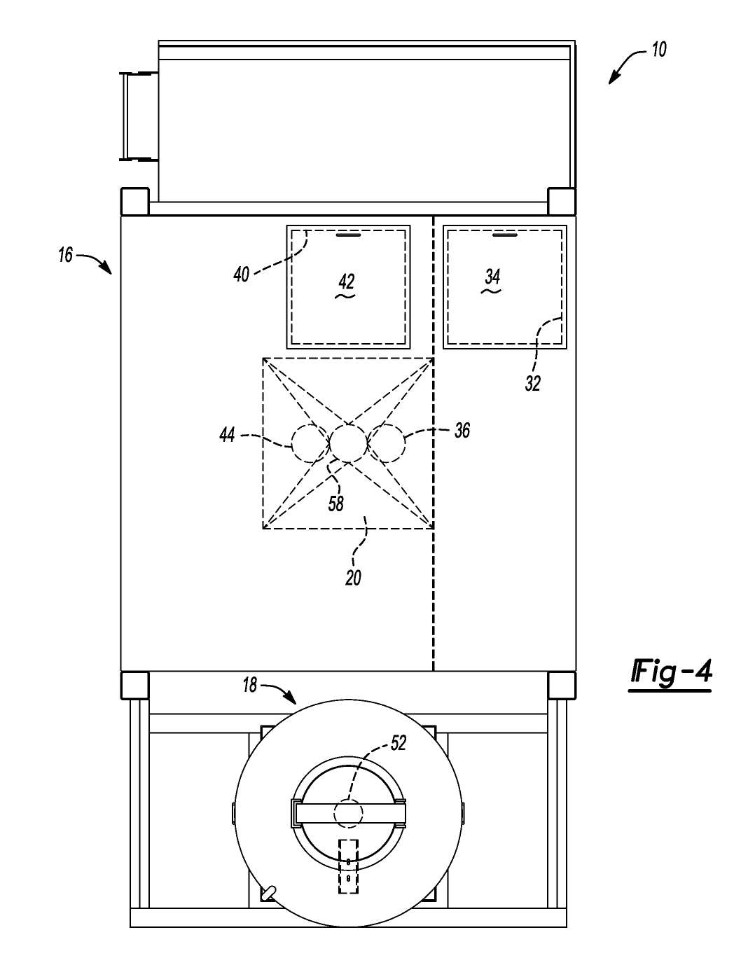

With reference to FIGS. 1-4, a cement handling system 10 may include a frame assembly 12, a first component container 14, a second component container 16, a third component container 18, an intermediate container 20, an aggregate container 22, a water supply assembly 24, and a weigh system 26. The frame assembly 12 may include a support structure 28 and legs 30. The legs 30 may be displaceable from a first position shown in FIG. 1 to a second position shown in FIG. 2. In the second position, the legs 30 may be displaced inwardly toward the support structure 28 to reduce an overall height of the cement handling system 10 during transportation thereof. The support structure 28 may support the first, second and third component containers 14, 16, 18, the intermediate container 20, the water supply assembly 24 and the weigh system 26.

The first component container 14 may include an inlet 32 at an upper end thereof, a hatch 34 overlying the inlet 32 to provide selective access to the interior of the first component container 14, an outlet 36 located at a lower end of the first component container 14, and a valve 38 in communication with the outlet 36. The first component container 14 may house a first mortar component therein. The outlet 36 and the valve 38 may cooperate to form a first metered opening.

Similarly, the second component container 16 may include an inlet 40 at an upper end thereof, a hatch 42 overlying the inlet 40 to provide selective access to the interior of the second component container 16, an outlet 44 located at a lower end of the second component container 16, and a valve 46 in communication with the outlet 44. The second component container 16 may house a second mortar component therein. The outlet 44 and the valve 46 may cooperate to form a second metered opening.

The third component container 18 may also include an inlet 48 at an upper end thereof, a hatch 50 overlying the inlet 48 to provide selective access to the interior of the third component container 18, an outlet 52 located at a lower end of the third component container 18, and a valve 54 in communication with the outlet 52. The third component container 18 may house a third mortar component therein. The outlet 52 and the valve 54 may cooperate to form a third metered opening.

The intermediate container 20 may include an inlet 56, an outlet 58 and a valve 60. The inlet 56 may be in communication with the first, second and third mortar components housed within the first, second and third component containers 14, 16, 18 when the valves 38, 46, 54 are in an open position. The outlet 58 and valve 60 may cooperate to form a fourth metered opening in communication with the aggregate container 22. The aggregate container 22 may be housed within legs 30 when legs 30 are in the first position, and may be located generally beneath the support structure 28. More specifically, the aggregate container 22 may be located beneath the first, second and third component containers 14, 16, 18, as well as below the intermediate container 20. The aggregate container 22 may additionally include a mixing device (not shown) and may be removable from the frame assembly 12. Alternatively, it is understood that a system may be provided without the use of the intermediate container 20 where the mortar components are provided directly to the aggregate container 22.

The water supply assembly 24 may include a water tank 62, a temperature control mechanism 64, a flow meter 66, a valve 68, and an outlet 70. The water tank 62 may house a supply of water and the temperature control mechanism 64 may heat the water to a predetermined temperature. The flow meter 66 may determine a volume of water exiting the water tank 62 via outlet 70. The valve 68 may control the volume of water exiting the outlet 70.

The weigh system 26 may include a weight sensor (load cell) 72 coupled to the support structure 28 and the intermediate container 20. The weight sensor 72 may determine the weight of a mixture contained within the intermediate container 20. In an alternate arrangement (not shown), a weigh system may include weight sensors for each of the first, second and third component containers 14, 16, 18. As such, a weigh system can be designed for a gain of weight system or a loss of weight system depending on the application.

The cement handling system 10 may further include a controller 74. The controller 74 may include a control panel 75 located in various places on the unit. The controller 74 may also include a wireless device (not shown) that will transmit information to the controller 74 located on the unit that gives it commands. The controller 74 may include a programmable logic controller (PLC) and may control the mixture and water supplied to the aggregate container 22. More specifically, the controller 74 may be in electrical communication with the valves 38, 46, 54, the valve 60 of the intermediate container 20, the temperature control mechanism 64, the flow meter 66, the valve 68 of the water supply assembly 24, and the weight sensor 72.

The controller 74 may provide a predetermined mixture of the first, second and third mortar components from the first, second and third component containers 14, 16, 18 by controlling an opening of the valves 38, 46, 54. In one arrangement, the material flow rate of the first, second and third mortar components is known when the valves 38, 46, 54 are in the open position. The combination of the controller 74 and valves 38, 46, 54 in this arrangement generally forms a volumetric control system.

In order to accurately determine the composition of the mixture provided to the intermediate container 20, the controller 74 may first open the valve 38 for a first predetermined time. Once a desired amount of the first mortar component corresponding to the first predetermined time is provided to the intermediate container 20, the controller 74 closes the valve 38. The weight sensor 72 then determines the weight of the first mortar component provided to the intermediate container 20.

Once the valve 38 is closed and the weight of the first mortar component within the intermediate container 20 is determined, the second valve 46 is opened for a second predetermined time to provide a predetermined quantity of the second mortar component to the intermediate container 20. The weight sensor 72 again determines the total weight of the first and second mortar components contained in the intermediate container 20. The weight of the second mortar component is determined by subtracting the previously determined weight of the first mortar component from the total weight.

Once the valve 46 has been closed and the weight of the first and second mortar components is determined, the valve 54 is opened to provide a predetermined quantity of the third mortar component to the intermediate container 20. The weight sensor 72 again determines the total weight of the first, second and third mortar components contained in the intermediate container 20. As before, the weight of the third mortar component is determined, for example, by subtracting the previously determined weight of the first and second mortar components from the new total weight. The controller 74 then knows the composition of the mixture containing the first, second and third mortar components, as well as the total weight.

While described as including first, second and third component containers 14, 16, 18, it is understood that the present disclosure is in no way limited to three component containers and/or three mortar components and that the use of fewer or more component containers and/or mortar components is within the scope of the present disclosure. Example components may include cement, sand, colored dye, slag, kaolin clay, silica fume, fly ash, and all grades of gravel, limestone or slag aggregate and admixtures, stainless steel slag, pumas, bottom ash, calcium carbonate, or any other mortar component. The first, second, and third mortar components may be different from one another. By way of non-limiting example, the first mortar component may include one of sand, cement, and a color dye, the second mortar component may include another of sand, cement, and a color dye, and the third mortar component may include another of sand, cement, and a color dye.

As discussed above, once the first, second and third mortar components are provided to the intermediate container 20, the controller 74 may determine the combined amount of substance contained within the intermediate container 20 via the weight sensor 72. The valve 60 of the intermediate container 20 may then be opened by the controller 74 to provide the mixture to the aggregate container 22. Alternatively, the valve 60 may be opened manually. The controller 74 may determine an appropriate quantity of water based on the determined amount of substance supplied by the intermediate container 20. The quantity of water may be a predetermined volume based on the mass of the mixture of the first, second and third mortar components contained within the aggregate container 22.

The controller 74 may then open the valve 68 of the water supply assembly 24 to provide a water supply to the mixture. The opening duration of the valve 68 may be determined based on the volume of water determined by flow meter 66. Additionally, the temperature of the water provided to the aggregate container 22 may be controlled by the temperature control mechanism 64. The water temperature may be maintained at a temperature of between 75 and 80 degrees Fahrenheit, and more specifically at approximately 78 degrees Fahrenheit.

The controller 74 may be programmed to provide a desired mixture of substances and water to the aggregate container 22, providing a consistent and repeatable mixture. The cement handling system 10 may be capable of transport to a specific work site, eliminating the need to use pre-made mixtures of mortar components.

What is claimed is:

1. A cement handling system comprising:
an aggregate container;
an intermediate container including an outlet in communication with the aggregate container and an inlet for receiving first and second mortar components;
a first component container housing the first mortar component and including a first metered opening located directly above the inlet of the intermediate container;
a second component container isolated from the first component container and housing the second mortar component, the second component container including a second metered opening located directly above the inlet of the intermediate container; and
a metered water supply in communication with the aggregate container.

2. The cement handling system of claim 1, wherein the first mortar component includes one of sand, cement, and a color dye and the second mortar component is different from the first mortar component and includes another of sand, cement, and a color dye.

3. The cement handling system of claim 1, further comprising a weigh system sensing a first amount of the first mortar component provided by the first metered opening to the intermediate container and a second amount of the second mortar component provided by the second metered opening to the intermediate container.

4. The cement handling system of claim 3, further comprising a controller in communication with the weigh system and the metered water supply, the controller receiving a signal indicative of the weight of the first and second amounts and providing a predetermined quantity of water to the aggregate container based on the first and second amounts.

5. The cement handling system of claim 4, wherein the intermediate container includes a third metered opening at a lower end located directly above the aggregate container and operable to selectively discharge the first and second mortar components directly into the aggregate container below.

6. The cement handling system of claim 5, wherein the weigh system includes a weight sensor operably connected to the intermediate container, the weight sensor providing the signal indicative of the weight of the first and second amounts to the controller.

7. The cement handling system of claim 6, wherein the controller is in communication with the first and second metered openings, the first and second amounts being predetermined and controlled by the controller.

8. The cement handling system of claim 1, wherein the metered water supply includes a temperature control mechanism that provides water to the aggregate container at a predetermined temperature.

9. The cement handling system of claim 1, further comprising a third component container isolated from the first and second containers and including a third metered opening in communication with the aggregate container.

10. The cement handling system of claim 1, further comprising a frame assembly supporting the first and second component containers.

11. The cement handling system of claim 10, wherein the frame assembly includes collapsible support legs displaceable between first and second positions to reduce a height of the cement handling system during transportation thereof.

12. The cement handling system of claim 1, further comprising a volumetric control system determining a first volume of the first mortar component provided by the first metered opening to the intermediate container and a second volume of the second mortar component provided by the second metered opening to the intermediate container.

13. A method comprising:
segregating first and second mortar components from one another at a worksite in a first component container including a first metered opening and a second component container including a second metered opening adjacent the first metered opening;
opening the first metered opening at the worksite for a first predetermined time to provide a first predetermined amount of the first mortar component directly to an intermediate container;
opening the second metered opening at the worksite for a second predetermined time to provide a second predetermined amount of the second mortar component directly to the intermediate container;
discharging a mixture of the first and second predetermined amounts at the worksite from a third metered opening in the intermediate container directly to the aggregate container; and
providing a predetermined amount of water to the aggregate container based on the first and second predetermined amounts.

14. The method of claim 13, further comprising determining a first weight of the first predetermined amount and a second weight of the second predetermined amount, the predetermined amount of water being determined based on the first and second weights.

15. The method of claim 14, wherein a controller determines the first and second predetermined times based on a desired composition of the mixture.

16. The method of claim 14, further comprising weighing the intermediate container to determine the first and second weights.

17. The method of claim 16, wherein the mixture is discharged after the first and second weights are determined.

18. The method of claim 13, further comprising inputting a desired composition of the mixture into a controller, the controller performing the opening the first and second component containers and the providing the predetermined amount of water.

19. The method of claim 18, wherein the opening the first metered opening includes selectively actuating a first valve in communication with a first outlet of the first component container and the opening the second metered opening includes selectively actuating a second valve in communication with a second outlet of the second container.

20. The method of claim 13, further comprising heating the water provided to the aggregate container to a predetermined temperature.
